(19) United States
(12) Patent Application Publication
(10) Pub. No.: US 2016/0078553 A1
(43) Pub. Date: Mar. 17, 2016

(54) Device Account Upgrade-At-Claim

(71) Applicant: ASURION, LLC, Kansas City, MO (US)

(72) Inventors: Jeff Kulla, Kansas City, MO (US); Shawn Hall, Kansas City, MO (US)

(73) Assignee: ASURION, LLC, Kansas City, MO (US)

(21) Appl. No.: 14/947,713

(22) Filed: Nov. 20, 2015

Related U.S. Application Data
(63) Continuation of application No. 14/053,392, filed on Oct. 14, 2013, now abandoned.
Application No. 14/053,392 is a continuation-in-part of application No. 13/972,992, filed on Aug. 22, 2013, now abandoned.
Application No. 13/972,992 is a continuation of application No. 13/716,979, filed on Dec. 17, 2012, now abandoned.
Application No. 13/716,979 is a continuation of application No. 13/459,688, filed on Apr. 30, 2012, now abandoned.
Application No. 13/459,688 is a continuation of application No. 13/233,756, filed on Sep. 15, 2011, now abandoned.
Application No. 13/233,756 is a continuation of application No. 13/019,760, filed on Feb. 2, 2011, now abandoned.
Application No. 13/019,760 is a continuation of application No. 12/821,875, filed on Jun. 23, 2010, now abandoned.
Application No. 12/821,875 is a continuation of application No. 12/614,823, filed on Nov. 9, 2009, now abandoned.
(60) Provisional application No. 61/112,433, filed on Nov. 7, 2008.

(51) Int. Cl. G06Q 40/08; G06Q 30/00

(52) U.S. Cl. CPC G06Q 40/08; G06Q 30/012

(57) ABSTRACT

A method of upgrading a device account is provided, the method comprising: disposing a processor in communication with a software package, wherein said software package is capable of receiving a data file containing a current device account status indicator from a device account status data provider; referencing said data file to inform a decision regarding whether a device account owner is eligible for an account upgrade at the time a device account claim is processed; and notifying said owner whether a device protection account upgrade is available. A related system appropriate for upgrading a device account is also provided, the system comprising: a processor disposed in communication with a software package, wherein said software package is programmed with means for receiving a data file containing a current device account status indicator from a device account status data provider; means for referencing said data file to inform a decision regarding whether a device account owner is eligible for an account upgrade at the time a device account claim is processed; and means for notifying said device account owner whether a device account upgrade is available.

### FIELD OF THE INVENTION

The present invention relates generally to electronic device accounts, and in a particular though non-limiting embodiment to a software-driven device account option in which customers are evaluated for eligibility for equipment, service and/or plan upgrades at the time a replacement program or service plan claim is filed.

### BACKGROUND

Currently, customers are limited to only a few options for protecting their wireless handset investment. Generally, a customer's available options are provided only at the time of purchase of a new phone (whether a replacement or a new contract). Regardless of the reason for purchase, customers are generally made aware of various options for protecting the value of the newly purchased phone; typically, these options include some type of protection coverage against lost, theft, malfunction and damage.

Provided the customer has purchased a phone from an authorized agent of the wireless carrier, they are usually generally eligible to enroll for protection coverage within 15-30 days of the date of the equipment purchase. The cost of the coverage is usually based on the specific equipment being purchased, and is billed to the customer on a monthly wireless invoice. The coverage is typically assigned to a single phone registered to the customer's wireless phone number (“Line Level Protection”). Therefore, if a customer has multiple wirelesses phone numbers they will pay premiums for each phone they elected to protect.

When a loss occurs, customers become eligible for a replacement device through their insurance coverage. The replacement process usually begins with a phone call to the insurer. Once information is collected from the claimant, it is evaluated by the carrier for claim eligibility. Assuming eligibility is approved, a deductible payment is then collected or billed and the replacement device is authorized for delivery.

Generally, customers receive a replacement device within 2-3 business days, or in some cases by visiting an authorized carrier store. Once the replacement phone is shipped or picked up at a wireless carrier store, the issue is considered resolved and the customer's account is adjusted to reflect a claim has been completed and the number of claims remaining are tracked under the single line account. The coverage generally provides a maximum benefit per line per year, for example, 2 or 3 replacement devices in a year is not atypical.

Currently known protection schemes are deficient, however, in that they typically provide only comparable model replacement options (as agreed in the original policy), and model upgrades during claim resolution are not available. There is, therefore, a long-felt but unmet need for an efficient, reliable method and means for allowing replacement claim customers greater choice in their purchasing decisions by automatically offering more upgrade options at the time of claim.

### SUMMARY OF THE INVENTION

A method of upgrading a device account is provided, the method comprising: disposing a processor in communication with a software package, wherein said software package is capable of receiving a data file containing a current device account status indicator from a device account status data provider; referencing said data file to inform a decision regarding whether a device account owner is eligible for an account upgrade at the time a device account claim is processed; and notifying said device account owner whether a device account upgrade is available.

In various other embodiments, the method comprises programming the software so as to enable one or more of the following functionalities: changing the brand of a protected device after processing an eligible account upgrade request; changing the model of a protected device after processing an eligible account upgrade request; expanding or reducing the scope of services associated with a device account after processing an eligible account upgrade request; enabling a device account owner-requested change in a device account after processing an eligible account upgrade request without extending the term of the device account; enabling a device account owner-requested change in a device account in a single transaction after processing an eligible account upgrade request; correlating device account owner enrollment data and device account owner claims data when assessing whether an account upgrade request is eligible; obtaining either or both of said enrollment data and said claims data from a database maintained by an associated system operator; obtaining either or both of said enrollment data and said claims data from a database maintained by an external database service; and/or tracking and managing fulfillment of an approved account upgrade request.

A related system appropriate for upgrading a device account is also provided, the system comprising: a processor disposed in communication with a software package, wherein said software package is programmed with means for receiving a data file containing a current device account status indicator from a device account status data provider; means for referencing said data file to inform a decision regarding whether a device account owner is eligible for an account upgrade at the time a device account claim is processed; and means for notifying said owner whether a device protection account upgrade is available.

In various other embodiments, the software package further comprises one or more of means for changing the brand of a protected device after processing an eligible account upgrade request; means for changing the model of a protected device after processing an eligible account upgrade request; means for expanding or reducing the scope of services associated with a device account after processing an eligible account upgrade request; means for enabling a device account owner-requested change in a device account after processing an eligible account upgrade request, without extending the term of the device account; means for enabling a device account owner requested change in a device account in a single transaction after processing an eligible account upgrade request; means for correlating device account owner enrollment data and device account owner claims data when assessing whether an account upgrade request is eligible; means for obtaining either or both of said enrollment data and said claims data from a database maintained by an associated system operator; means for obtaining either or both of said enrollment data and said claims data from a database maintained by an external database service; and/or means for tracking and managing fulfillment of an approved account upgrade request.

### DETAILED DESCRIPTION OF SEVERAL EXAMPLE EMBODIMENTS

An upgrade-at-claim device account option represents a significant opportunity to increase the value of device protection policies, wireless account plans, service plans and other device account programs. In one particular though non-limiting embodiment, customers electing to upgrade at the time a claim is being resolved enjoy more service options and greater flexibility in their purchase and coverage options, for example, customers can obtain one or more of a different brand or model of equipment; enhanced capabilities through the carrier network; newer, more recent or later generation technology upgrade options that do not necessarily extend their current contract, and/or the convenience of a single transaction.

By allowing customers the freedom of choice to elect an upgrade to a more current device or different service or coverage options at a low price in a single transaction, customers are able to obtain and enjoy the most current technology in a single transaction with little or no impact to their contract or associated carrier program.

By incorporating this valuable functionality into a software program disposed in communication with a computer processor and a browser or other program interface, appropriately programmed software can assess, manage and track customer eligibility for the program, available customer options at the time a claim is being resolved, and fulfillment of customer change orders regarding model, service and coverage upgrades at the time of claim.

Within the context of this application, the phrases “appropriately programmed software”, “software package” and “means for [some particular functionality stated herein and its equivalents]” mean a software program or a software package with appropriate hardware/software/firmware interface means as to enable the various software-related functionality described and inherently inferred herein, such as machine code, source code, object code, code operators and indicators and the like that act directly or indirectly, with or without the temporal assistance of related hardware or firmware, in order to carry out at least the functionality specified herein, regardless of whether such functionality or means therefor are presently known or future devised, so long as said functionality and means therefor reside within the present understanding of one of ordinary skill in the art.

In one embodiment, the appropriately programmed software assists a customer service representative in carrying out such tasks. In a further embodiment, the software package itself serves as the customer service representative by offering customers access to a suite or menu of prerecorded options that customers access by either pushing one or more predefined phone button combinations or by voice activation, or by a combination thereof. In a further embodiment, customer access is provided over the Internet, for example, by means of a satisfactorily compatible web browser disposed in communication with the software package.

In one example embodiment, when customers call a provider to file a claim for an associated wireless phone loss, then based on that specific customer's eligibility a customer service representative helps the customer either file a claim and receive a “like-for-like” replacement through the standard insurance process, or instead identify eligibility to upgrade their handset by paying an upgrade-at-claim related fee and then assisting in the fulfillment of that change order.

In another embodiment, an appropriately programmed software package relates data stored in communication with a processor or the like relating to a customer's eligibility and an interface that allows either a customer or a customer service representative to automatically reference a customer's upgrade eligibility profile, and then elect either a standard insurance option in which the customer will receive a like-for-like replacement, or an upgrade option, in which available options such as a change in device brand and/or a device model upgrade, service plan upgrade, or coverage plan upgrade, are offered to customers in exchange for an upgrade option fee and/or a predetermined policy deductible.

In embodiments where the transaction is carried out by a customer service representative (or “CSR”) interacting with the processor and correspondingly programmed software, the CSR handles intake of the initial customer call, for example, using a defined script or decision tree diagram with preplanned suggestions for explaining the program to the customer. Using the selectively programmed software in communication with a corresponding eligibility file stored in or accessed by the processor, the CSR can then see in a browser window or other user interface whether the customer is in fact eligible for the upgrade-at-claim option.

In other example embodiments, customer eligibility is informed by correlating data obtained from customer enrollment data with subsequently obtained claims data so that program integrity and efficiency is maximized. In further embodiments, either (or both) enrollment data and claims data are recorded, stored and/or maintained by a system operator; in others, such data is recorded, stored and/or maintained by a vendor or other service provider ancillary to the operator, for example, a plan carrier or a retailer, etc.

In one embodiment, when a customer is deemed eligible, the CSR will follow up by asking an interest-gauging question designed to solicit a response from the customer indicative of whether the customer might be interested in the upgrade option. In embodiments where the software package itself serves as the CSR and/or customer interface, the customer might indicate their agreement of lack of agreement with the upgrade option by, for example, pressing the number 1 on their key pad for “yes” or the number 2 on their keypad for “no.”

Those of ordinary skill in the pertinent arts will readily appreciate that because of the very large number of ways a software package can be programmed to carry out similar functionalities, the examples provided above are illustrative in nature only, and are not intended to serve as an exhaustive recitation of methods and means by which customer eligibility can be determined, upgrade options can be made known to a customer, and/or fulfillment of upgrade option change orders can be initiated and completed.

For example, in one embodiment when customers are either not eligible for or not interested in an upgrade option, the CSR or software package simply completes the claim in a manner consistent with known insurance protocols. In instances, however, where customers are eligible for and interested in the upgrade option, the CSR facilitates transfer of the customer's call to an upgrade option action queue.

Depending on the specifics of the system and desired operational parameters, the action queue may comprise either a new menu or library of options from which the software system either proceeds with a series of customer inquiries either sequentially or in a random access mode based on predetermined weighting factors programmed and stored in the software or the processor (or in a data base or the like disposed in communication with but physically separate from either (or both) the software and processor). In another embodiment the upgrade queue process comprises transfer of the caller from the CSR to a sales agent (whether human or a pre-programmed part of the software package). In still another embodiment, the CSR serves as the sales agent once eligibility and customer acceptance have been confirmed.

In the upgrade queue, customer eligibility may (or may not) again be verified, and specifics relating to the upgrade option plan are presented to the customer. Once the specifics of the plan have been explained and either accepted or declined, the claim process is completed in a manner consistent with known replacement practices or in a manner consistent with the upgrade-at-claim process described and claimed herein.

In another embodiment, the upgrade-at-claim option is organized and programmed in a manner that maximizes program flexibility by allowing a plurality of equipment enrollment options that admit to a wide variety of specialized customer solutions and product differentiations among qualified clients. For example, a provider can program the system so that a customer eligibility and option files are updated daily, and identify upgrade eligible device account owners by mobile numbers. When a plan device account owner calls into the claim and update option system, the system looks up the caller's mobile number to see if they are on an associated upgrade eligibility list.

In one example embodiment, the upgrade option service is offered to customers at no additional cost and may be, for example, included with the customer's baseline handset insurance. In other embodiments, when a customer accepts an upgrade there are no changes to their contract with the associated wireless carrier. In still other embodiments, an upgrade accepted by the customer qualifies as an insurance claim for claim tracking purposes.

In further embodiments the customer remains responsible for payment of a standard insurance deductible, and in still further embodiments the upgrade equipment can be either new or remanufactured; typically, upgrade equipment pricing will vary according (e.g., buying a new upgrade will typically cost the customer more in upgrade fees than an upgraded but remanufactured handset.

In further embodiments, associated upgrade fees are based on the relative values of the equipment being surrendered and the upgraded equipment being acquired by the customer. Accordingly, the program or processor accessed stored data comprises relative assigned values for all possible claimed phones in a covered carrier program. In one such embodiment, customers receive an assigned values' worth of upgrade credit that can be applied towards the purchase of a new phone as part of the upgrade process.

In other embodiment, upgrade fees are tiered, and all claimed and replacement handsets are placed into data tiers according to one or more functionalities, technologies or price ranges. In one such embodiment, customers are able to move up (or down) in data tiers, and pay a set upgrade fee based on the number of tiers moved or crossed through in doing so.

In yet another embodiment, particularly relevant processes are processed and leveraged to from the outset in order to improve efficiency and management of the upgrade-at-claim plan, for example, confirming pre-qualification of an applicant at the time the plan is entered into.

In other embodiments the system comprises programmed methods and means for tracking sales of upgrade plans and/or equipment, service plans and coverage changes associated therewith.

According to still further embodiments, cooperative use of the system by third party sales agents is achieved, so that a sales order ordering and processing system is configured to accept a call routed from an associated call center, and the third party sales agents then offer upgraded handsets and service and coverage plans based on handset manufacturer, desired functionalities, upgrade fee tiers, etc. As discussed above, the system is programmed to admit to transfer of customers from a claims queue to a sales queue, and preferably, corresponding reports detailing attempted and actual sales data are created and stored for subsequent comparison purposes. Third party representative access should optimally also comprise the ability to look up customer eligibility; comparative equipment, service and plan pricing; prior claim information, etc.

In still other embodiments the system comprises the ability to track for accounting purposes one or more of the following: original claimant handset; original claim amount; and/or upgraded handset costs. Optimally the software is programmed to update a captive accounting line item detail containing information indicative of the difference between the original claimant handset value and the upgraded handset value.

The foregoing specification is provided for illustrative purposes only, and is not intended to describe all possible aspects of the present invention. Moreover, while the invention has been shown and described in detail with respect to several exemplary embodiments, those of ordinary skill in the art will appreciate that minor changes to the description, and various other modifications, omissions and additions may also be made without departing from the spirit or scope thereof.

1. A method of upgrading a device account, the method comprising:
disposing a processor in communication with a software package, wherein said software package is capable of
receiving a data file containing a current device account status indicator from a device account status data provider;
referencing said data file to inform a decision regarding whether a device account owner is eligible for an account upgrade at the time a device account claim is processed; and
notifying said device account owner whether a device account upgrade is available.

2. The method of upgrading a device account of claim 1, further comprising:
changing the brand of a protected device after processing an eligible account upgrade request.

3. The method of upgrading a device account of claim 1, further comprising:
changing the model of a protected device after processing an eligible account upgrade request.

4. The method of upgrading a device account of claim 1, further comprising:
expanding or reducing the scope of services associated with a device account after processing an eligible account upgrade request.

5. The method of upgrading a device account of claim 1, further comprising:
enabling an owner-requested change in a device account after processing an eligible account upgrade request without extending the term of the device account.

6. The method of upgrading a device account of claim 1, further comprising:
enabling an owner-requested change in a device account in a single transaction after processing an eligible account upgrade request.

7. The method of upgrading a device account of claim 1, wherein said software package is further capable of:
correlating owner enrollment data and owner claims data when assessing whether an account upgrade request is eligible.

8. The method of upgrading a device account of claim 7, further comprising:
obtaining either or both of said enrollment data and said claims data from a database maintained by an associated system operator.

9. The method of upgrading a device account of claim 7, further comprising:
obtaining either or both of said enrollment data and said claims data from a database maintained by an external database service.

10. The method of upgrading a device account of claim 1, wherein said software package is further capable of:
tracking and managing fulfillment of an approved account upgrade request.

11. A system for upgrading a device account, the system comprising:
a processor disposed in communication with a software package, wherein said software package is programmed with
means for receiving a data file containing a current device account status indicator from a device account status data provider;
means for referencing said data file to inform a decision regarding whether a device account owner is eligible for an account upgrade at the time a device account claim is processed; and
means for notifying said owner whether a device account upgrade is available.

12. The system for upgrading a device account of claim 11, wherein said software package is further programmed with means for changing the brand of a protected device after processing an eligible account upgrade request.

13. The system for upgrading a device account of claim 11, wherein said software package is further programmed with means for changing the model of a protected device after processing an eligible account upgrade request.

14. The system for upgrading a device account of claim 11, wherein said software package is further programmed with means for expanding or reducing the scope of services associated with the device account after processing an eligible account upgrade request.

15. The system for upgrading a device account of claim 11, wherein said software package is further programmed with means for enabling an owner-requested change in the device account after processing an eligible account upgrade request without extending the term of the device account.

16. The system for upgrading a device account of claim 1 wherein said software package is further programmed with means for enabling an owner-requested change in a device account in a single transaction after processing an eligible account upgrade request.

17. The system for upgrading a device account of claim 11, wherein said software package is further programmed with means for correlating owner enrollment data and owner claims data when assessing whether an account upgrade request is eligible.

18. The system for upgrading a device account of claim 17, wherein said software package is further programmed with means for obtaining either or both of said enrollment data and said claims data from a database maintained by an associated system operator.

19. The system for upgrading a device account of claim 17, wherein said software package is programmed with means for obtaining either or both of said enrollment data and said claims data from a database maintained by an external database service.

20. The system for upgrading a device account of claim 11, wherein said software package is further programmed with means for tracking and managing fulfillment of an approved account upgrade request.
